(19) United States
(12) Patent Application Publication
(10) Pub. No.: US 2008/0275709 A1
(43) Pub. Date: Nov. 6, 2008

(54) Audio Encoding and Decoding

(75) Inventors: Albertus Cornelis Den Brinker, Eindhoven (NL); Andreas Johannes Gerrits, Eindhoven (NL); Felipe Riera Palou, Palma de Mallorca (ES)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,539

(22) PCT Filed: Jun. 15, 2005
(86) PCT No.: PCT/IB05/51972

§ 371 Date: Dec. 13, 2006

(30) Foreign Application Priority Data
Jun. 22, 2004 (EP) 04102880.4

(51) Int. Cl. G10L 19/00; G06F 17/00

(52) U.S. Cl. 704/500; 700/94; 704/E19.001

(57) ABSTRACT

A method of encoding a digital audio signal, wherein for each time segment the signal is spectrally flattened to obtain a spectrally flattened signal (r) and possibly spectral flattening parameters (LPP). The spectrally flattened signal is modelled by an excitation signal comprising a first partial excitation signal (pₓ) conforming to an excitation signal generated by an RPE or CELP technique, and a second partial excitation signal (P_{E}_{ₚ}) being a set of extra pulses with arbitrary positions and amplitudes. An audio bit stream as comprising the first and second partial excitation signals is generated. The extra pulses can be added to the excitation signal at positions in time that correspond to the time of occurrence of the spike, or preferably at positions in time of an RPE time grid.

The present invention relates to encoding and decoding of broadband signals, in particular audio signals such as speech signals. The invention relates both to an encoder and a decoder, and to an audio bit stream encoded in accordance with the invention and a data storage medium on which such an audio bit stream has been stored.

When transmitting broadband signals, e.g. audio signals sampled at 32 kHz or higher (which includes speech signals), compression or encoding techniques are used to reduce the bit rate of the signal, whereby the bandwidth needed for transmission is reduced correspondingly.

Linear predictive coding (LPC) is a technique often used in speech encoding. The main idea of LPC is to pass the input signal through a prediction filter (analysis) whose output signal is a spectrally flattened signal. The spectrally flattened signal can be encoded using fewer bits. The bit rate reduction is achieved by retaining an important part of the signal structure in the prediction filter parameters, which vary slowly over time. The spectrally flattened signal coming out of the prediction filter is usually referred to as the residual. The terms residual and flattened signal are thus synonyms that are used interchangeably.

In order to further reduce the required bit rate, a modelling process is applied to the flattened signal to derive a new signal called an excitation signal. This procedure is referred to as residual modelling. The excitation signal is computed in such a way that when passed through the prediction synthesis filter, it produces a close approximation (according to an appropriate criterion) of the output produced when the spectrally flattened signal is used in the synthesis. This process is called analysis-by-synthesis. Certain constraints imposed on the form of the excitation signal, make its representation very efficient from a bit rate point-of-view.

Three popular methods of computing the excitation signal are the regular pulse excitation (RPE) [1], the multi-pulse excitation (MPE) [2] and CELP-like methods [10]. They basically differ in the constraints imposed on the excitation signal. In RPE the excitation is bounded to consist of equally spaced non-zero values with zeros in between. For narrowband speech (e.g. 8 kHz sampling), decimation factors of 2, 4 and 8 are common. In MPE, on the other hand, very few pulses are used (typically 3-4 for every 5 ms of narrowband speech) but they are not subject to any grid and can be placed anywhere. Usually, the error introduced by the quantisation is also taken into account when computing the excitation. Both methods, RPE and MPE, have been shown to deliver similar performance for the same bit rate. In CELP, a sparse codebook can be used to attain a high compression factor.

Linear predictive coding removes the short-term correlation among input samples, but due to the short length of the analysis filter LPC can do little to remove long-term correlations. Long-term correlations are often present in the flattened signal and they are mainly caused by (quasi) periodicities, which in the case of speech correspond to the voiced utterances. These periodicities become clearly apparent in the residual signal in the form of pulse trains (see FIG. 8a). A subsequent modelling stage with coarse quantisation will have difficulties in modelling segments that include these nearly periodic pulses due to their high dynamic range, resulting in a poor excitation. This can be prevented by removing these periodic structures from the residual using a long-term predictor (LTP) [3] thereby creating a new residual that is input to the residual modelling stage [5]. The long-term linear predictor is typically described by a delay and a small set of prediction coefficients.

Although the waveform is not exactly periodic, these deviations from ideal periodicity do not greatly affect the LTP performance in the case of narrowband signals (8 kHz sampling) because the time span covered by a single delay is sufficient to absorb the drift in the waveform period. Moreover, LTPs with 2 or 3 prediction coefficients make the system more robust to these fluctuations. LTPs with more than three prediction coefficients are not practical as the longer the filters are, the more prone to instability they become and the more involved the stabilization procedure is [4]. LTPs are successfully used in most current speech encoders.

The application of LPC and pulse excitation to the encoding of broadband (44.1 kHz sampling) speech and audio signals has also been tested, with limited success, some years ago [5, 6]. However, recent developments in the area of linear prediction [7] have renewed the interest in these techniques and some novel work on linear prediction broadband encoding has recently been published [8, 9].

The use of long-term prediction in broadband speech and audio encoding presents several difficulties, which are not encountered in narrowband speech and are caused by the high sampling rate employed (32 kHz or higher). First, and unlike the narrowband situation, a large number of LTP prediction coefficients are required in the LTP to successfully track the fluctuations in the residual periodicities. As it has already been mentioned, LTPs involving more than a few prediction coefficients are unpractical due to instability problems [4]. Short LTPs (1, 2 or 3 prediction coefficients) can be used but the gain achieved by them is minimal. An additional problem is the high computational complexity of the search for the optimum delay. This is due to the fact that signal segments contain a much larger number of samples in comparison to narrowband signals.

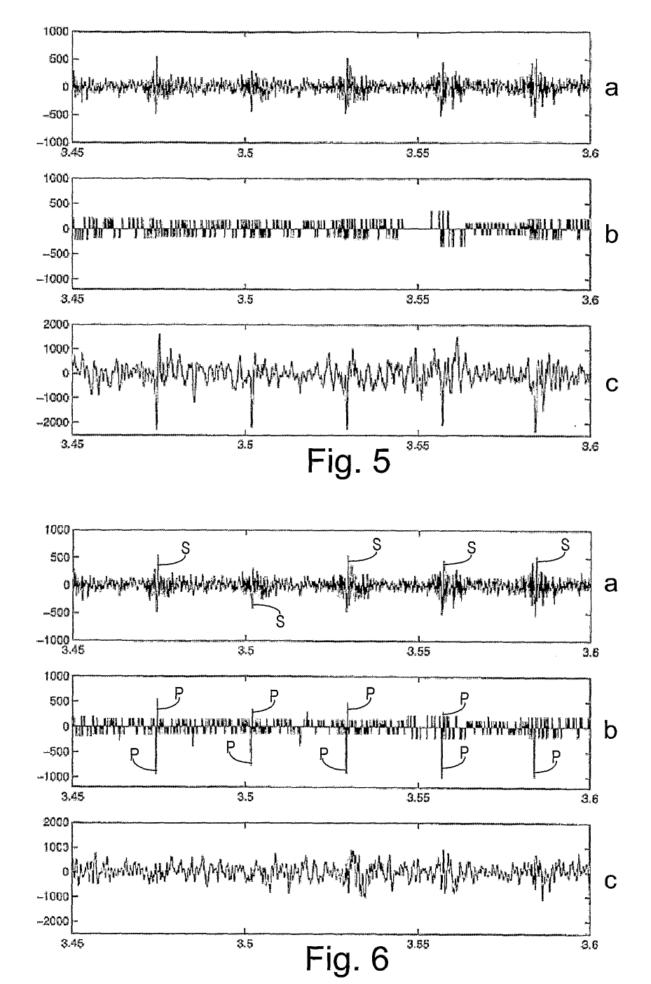

Both reasons make the use of LTP unsuitable in broadband (44.1 kHz sampling) audio or speech encoding. Nevertheless, quasi-periodic pulse trains are present in the residual signal and may cause serious problems to the subsequent pulse modelling stage. As an example, FIG. 5a shows several frames (1,500 samples in frames of 240 samples) of the residual signal corresponding to a voiced part in German male speech. The quasi-periodic structure is clearly present. FIG. 5b shows the RPE signal with decimation 2 and 3-level quantisation computed from the residual. Finally, FIG. 5c shows the error between the original and reconstructed signals. The peaks in the error signal closely follow the peaks in the residual indicating that the pulse modelling is not very good in these segments. In general, it has been found experimentally that, in speech signals, modelling errors in voiced segments result in a perceived loss of presence in the coded signal.

The final signal quality achieved by a conventional pulse encoder is mainly determined by two parameters, namely, the number of pulses per frame and the number of levels used to quantise the resulting pulses. The higher the number of pulses and the number of quantisation levels, the more accurate the representation of the coded signal becomes. On the other hand, in order to achieve a high degree of compression, the number of pulses and quantisation levels must be minimized.

Independently of the number of pulses per frame used, very coarse quantisation of a signal is problematic whenever the signal exhibits a large dynamic range, as some parts of the signal will not be properly represented. This is the situation encountered in residuals that contain occasional large signal amplitudes in a quasi-periodic way (pulse-train like periodicities). The problem is exacerbated when some of the samples are forced to be zero, as it is done in RPE or MPE and also when sparse codebookns are used as its done in CELP coders.

The inventors appreciate that the different analysis-by-synthesis techniques used currently in speech coding like RPE, MPE or CELP (or variants thereof) for modelling of the residual are insufficient in broadband coding due to the lack of a proper functioning LTP mechanism for this situation. The combination of either RPE and a few extra pulses or CELP and a few extra pulses mitigates this problem because the extra pulses can be effectively used to model the quasi-periodic spikes typically appearing in residual signals exhibiting long-term correlation.

The invention relates to a method of encoding a digital audio signal, wherein for each time segment of the signal the following steps are performed:

spectrally flattening the signal to obtain a spectrally flattened signal,

modelling the spectrally flattened signal by an excitation signal comprising first and second partial excitation signals,

the first partial excitation signal conforming to an excitation signal generated by an RPE or CELP pulse modelling technique,

the second partial excitation signal being a set of extra pulses modelling spikes in the spectrally flattened signal, the extra pulses having arbitrary positions and amplitudes,

and

generating an audio bit stream comprising the first and second partial excitation signals.

The invention also relates to an audio encoder adapted to encode time segments of a digital audio signal, the encoder comprising

a spectral flattening unit for spectrally flattening the signal to output a spectrally flattened signal,

a calculating unit adapted to calculate, an excitation signal comprising first and second partial excitation signals,

the first partial excitation signal conforming to an excitation signal generated by an RPE or CELP technique

the second partial excitation signal being a set of extra pulses modelling spikes in the spectrally flattened signal, the extra pulses having arbitrary positions and amplitudes,

and

an audio bit stream generator for generating an audio bit stream comprising the first and second partial excitation signals.

Further, the invention relates to a method of decoding a received audio bit stream, where the audio bit stream comprises, for each of a plurality of segments of an audio signal:

a first partial excitation signal conforming to an excitation signal generated by an RPE or CELP pulse modelling technique,

a second partial excitation signal being a set of extra pulses modelling spikes in the spectrally flattened signal, the extra pulses having arbitrary positions and amplitudes,

the method comprising means for synthesising an output signal on the basis of the combined first and second excitation signals and the spectral flattening parameters.

Correspondingly, the invention relates to an audio player for receiving and decoding an audio bit stream, where the audio bit stream comprises for each of a plurality of segments of an audio signal:

a first partial excitation signal conforming to an excitation signal generated by an RPE or CELP technique,

a second partial excitation signal being a set of extra pulses modelling spikes in the spectrally flattened signal, the extra pulses having arbitrary positions and amplitudes,

the audio player comprising means for synthesising an output signal from the combined partial excitation signals and spectral flattening parameters.

Finally, the invention relates to an audio bit stream comprising for each of a plurality of segments of an audio signal:

a first partial excitation signal conforming to an excitation signal generated by an RPE or CELP technique,

a second partial excitation signal being a set of extra pulses modelling spikes in the spectrally flattened signal, the extra pulses having arbitrary positions and amplitudes;

and to a storage medium having such an audio bit stream stored thereon.

Embodiments of the invention will now be described, by way of example, with reference to the accompanying drawings, in which:

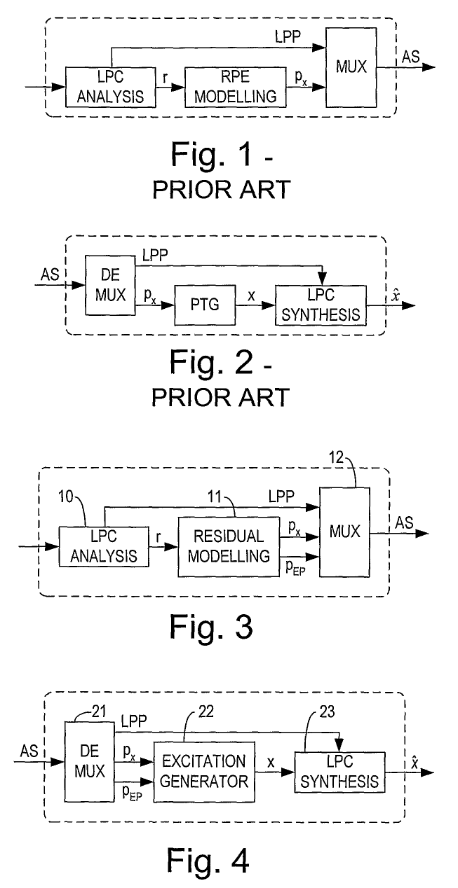

FIG. 1 shows an encoder according to prior art;

FIG. 2 shows a decoder compatible with the encoder of FIG. 1;

FIG. 3 shows the preferred embodiment of an encoder according to the present invention;

FIG. 4 shows the preferred embodiment of a decoder compatible with the encoder of FIG. 3 according to the present invention;

FIG. 5 shows an example of a German male speech residual (5a) encoded using traditional RPE encoding (5b) and the associated error (5c), and

FIG. 6 shows an example of a German male speech residual (6a, identical to 5a) encoded using the method of the invention (6b) and the associated reduced error (6c).

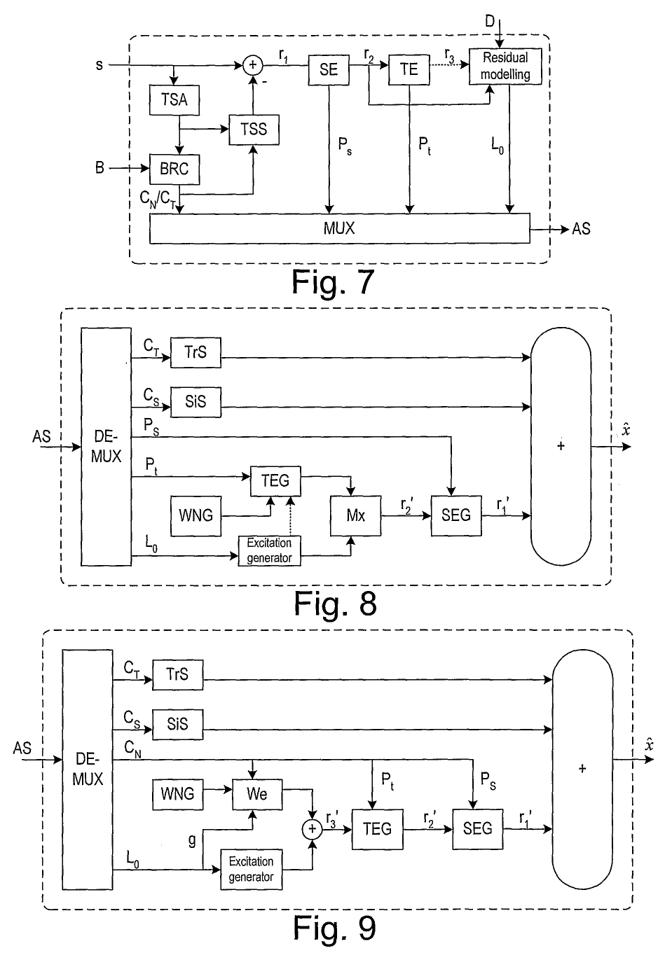

FIG. 7 shows an embodiment of an encoder combining a parametric encoder with the encoder of FIG. 3;

FIG. 8 shows a first embodiment of a decoder compatible with the encoder of FIG. 7; and

FIG. 9 shows a second embodiment of a decoder compatible with the encoder of FIG. 7.

FIG. 1 shows a typical analysis-by-synthesis excitation encoder. In general the encoding process works on a frame-by-frame basis and consists of two steps: first the input signal is passed through a frame-varying linear prediction analysis filter (LPC) to obtain a spectrally flattened signal r, also referred to as the residual, and linear prediction parameters (LPP) describing the spectral flattening. The spectrally flattened signal r is fed to a residual modelling stage such as an RPE encoder in which a pulse modelling process is applied to the spectrally flattened signal to derive an excitation signal x. The parameters pₓ describing the excitation signal x and the parameters LPP are combined to an audio bit stream AS.

In FIG. 2 a typical analysis-by-synthesis decoder is shown. The decoder receives an audio bit stream AS comprising the parameters pₓ and the parameters LPP. The decoder generates the excitation signal x according to the parameters pₓ and feeds this to a linear prediction synthesis filter with filter parameters specified by the parameters LPP, which is also updated for every frame and generates an approximation of the original signal.

In accordance with the invention the problem of encoding of quasi-periodicities in the spectrally flattened signal, in particular pulse-like trains, is solved by extending the pulse model, whereby a conventional RPE signal is supplemented by additional pulses with free gains/positions, i.e. the positions in time of the added pulses are not necessarily dictated by the RPE time-grid nor are the gains of the extra pulses dictated by the quantisation grid of the conventional RPE signal. The objective of these extra pulses is to model the residual spikes that would otherwise not be modelled. Hereby more freedom is given to the RPE signal to model the rest of the signal. The extra pulses are thus added to more closely model the residual spikes. This procedure can be interpreted as the non-obvious fusion of RPE and MPE where the MPE pulses model the signal spikes and the RPE pulses model the rest of the residual. This procedure is non-obvious since until now RPE and MPE are considered to be competing techniques but in absence of an LTP, they can be made to act complementary.

Although the number of extra pulses, K, can be set arbitrarily, it will in practice be limited to 1 or 2 per frame. The reason for this is that the pitch in human speech is within the range 50-400 Hz, and processing usually takes place in 5 ms segments; consequently there are only one or two cycles, i.e. one or two large peaks, in any given segment.

In a preferred embodiment of the method of the invention the number of quantisation levels has been fixed to 3 (1, 0, −1). The decimation factor can be arbitrarily set, although decimations 2 and 8 are preferred for obtaining excellent and good quality, respectively. The very coarse quantisation of the pulses determines to a large extent the performance of the whole RPE scheme even with a decimation factor of 2.

According to the invention the joint RPE/extra pulses optimisation is performed for each frame and it works as follows: we start by computing a normal un-quantised RPE signal [1], the positions corresponding to the K (=number of extra pulses) largest magnitude pulses are selected as the extra pulse locations. The RPE signal is then quantised (3 levels) and a joint optimum computation of the gains for the RPE signal and each of the extra pulses is performed. This procedure is repeated for each possible RPE offset and the solution producing the lowest norm of the reconstruction error is selected. Therefore the excitation signal x will consist of two partial excitations; a conventional RPE excitation signal x_{RPE} and a second partial excitation signal consisting of a sum of delta functions gₖδₖ for k=1, . . . , K, where the delta function is defined as a signal of all zeros with an amplitude equal to 1 at one specific time instant only and gₖ is its associated gain.

In FIG. 3 is shown an embodiment of the encoder according to the present invention. The encoder receives a digital input signal, which is input to a linear prediction analysis filter 10 using linear prediction coding (LPC), which generates linear prediction parameters (LPP) and the residual r, which is spectrally flattened. The linear prediction parameters (LPP) are therefore also referred to as spectral flattening parameters. The residual r is input to the residual modelling stage 11, which as output generates parameters pₓ describing the excitation according to RPE or CELP constraints and parameters p_{EP} which describe the extra pulses. An audio bit stream generator 12 generates an audio bit stream AS by combining the parameters pₓ and p_{EP} describing the excitation signal. The spectral flattening parameters LPP may be included in the audio bit stream or they may be generated in the decoder using a backward-adaptive linear prediction algorithm.

In FIG. 4 is shown a decoder compatible with the encoder of FIG. 3. In a demultiplexer 21 the received audio bit stream AS is split into parameter streams corresponding to the linear prediction parameters (LPP), the RPE or CELP excitation signal parameters pₓ and the extra pulses parameters p_{EP}. The excitation generator 22 uses the parameters pₓ and p_{EP} to generate the excitation signal x. The excitation signal x is fed to the linear prediction synthesis filter 23, which as output produces an approximation of the input signal of the encoder. In case the parameters LPP are not included in the audio bit stream, these can be generated from \hat{x} using backward-adaptive linear prediction.

An efficient algorithm for calculating the two partial excitation signals in accordance with the block 11 ‘Residual Modelling’ from FIG. 3 for each incoming frame can be summarized as follows:

For every offset j do

Compute optimum RPE un-quantised amplitudes=>A(j)

Select positions of the K largest magnitude pulses

Generate K partial excitation signals=>δₖ(j), k=1, . . . , K

Quantise A(j)=>A_{q}(j)

Generate partial excitation signal from A_{q}(j)=>x(j)

Compute optimum gains=>gₓ(j), g₁(j), . . . , g_{K}(j)

Compose total excitation=>x(j)=gₓ(j)x_{RPE}(j)+g₁(j)δ₁(j)+ . . . +g_{K}δ_{K}(j)

Compute norm of reconstruction error for current offset j=>e(j) end

Select x(j) with minimum norm=>x^{opt}

The computation of the optimum RPE un-quantised amplitudes is done according to [1]. The calculation of the optimum gains is performed by solving the following linear equation system:

$$( \begin{matrix}{g}_{x} ( j ) \\ {g}_{1} ( j ) \\ ⋮ \\ {g}_{K} ( j )\end{matrix} ) = {( \begin{matrix}{s}_{x ( j )} {s}_{x ( j )}^{t} & {s}_{x ( j )} {s}_{{δ}_{1} ( j )}^{t} & … & {s}_{x ( j )} {s}_{{δ}_{K} ( j )}^{t} \\ {s}_{{δ}_{1} ( j )} {s}_{x ( j )}^{t} & {s}_{{δ}_{1} ( j )} {s}_{{δ}_{1} ( j )}^{t} & … & {s}_{{δ}_{1} ( j )} {s}_{{δ}_{K} ( j )}^{t} \\ ⋮ & ⋮ & ⋱ & ⋮ \\ {s}_{{δ}_{K} ( j )} {s}_{x ( j )}^{t} & {s}_{{δ}_{K - 1} ( j )} {s}_{x ( j )}^{t} & … & {s}_{{δ}_{K} ( j )} {s}_{{δ}_{K} ( j )}^{t}\end{matrix} )}^{- 1} ( \begin{matrix}{S}_{x ( j )} {s}^{t} \\ {s}_{{δ}_{1} ( j )} {s}^{t} \\ ⋮ \\ {s}_{{δ}_{K} ( j )} {s}^{t}\end{matrix} ) \qquad ( 1 )$$

where sₓ₍ⱼ₎ denotes the synthesised signal approximation component due to the RPE excitation (i.e. the convolution of x(j) with the impulse response of the synthesis filter), s_{δ}_{ᵢ₍ⱼ₎} denotes the synthesised signal approximation component due to the i^{th} extra pulse (i.e. the convolution of δᵢ(j) with the impulse response of the synthesis filter) and s denotes the original audio signal. This expression follows from the minimization of the error power between the original segment and its reconstruction from the partial excitations.

Notice that this procedure still conducts a joint, albeit sub-optimal, optimisation of the location and amplitude of the RPE signal and the extra pulses.

In order to design the optimum combined RPE/extra pulses signal, an exhaustive calculation, e.g. as above, is required. The very high complexity of this procedure motivates the need for simpler strategies to compute the joint RPE/extra pulses excitation.

Thus, in a preferred embodiment of the invention the extra pulses are restricted to be on the RPE grid, i.e. to be coincident with the RPE pulses. This means that the extra RPE pulses are not necessarily strictly coincident with the residual pulses that they model but are offset to the next or nearest RPE pulse grid position. This approach has two important advantages: The complexity of the encoder is drastically reduced, and the bit rate is reduced because the number of bits spent in encoding the positions of the extra pulses is reduced.

A consequence of the addition of extra pulses to a conventional RPE or CELP signal is an increase in bit rate. However the increase in bit rate is rather modest when compared to the total bit rate. As an example, the encoding of a 44,100 samples/s flattened signal using RPE with decimation 2 and 3-level quantisation (1.6 bit/pulse) results in a bit rate of around 40 kb/s. Assuming a 5 ms frame length, the addition of two extra pulses using the described technique raises the rate to around 43.6 kb/s.

It will be seen that in the provided algorithm there is no need for an elaborate search the positions of the extra pulses. Yet, the results indicate that the extra pulses obtained in this way and being restricted to the RPE grid are effective in removing pulse-like periodicities from the residuals.

FIGS. 6a-c illustrate the performance of the method according to the invention. FIG. 6a shows the same spectrally flattened signal as in FIG. 5a (German male speech residual) with periodic or quasi-periodic peaks or spikes S. FIG. 6b depicts the computed RPE signal (decimation 2, 3-level quantisation) with two extra pulses P added per frame, where the extra pulses serve to model the quasi-periodic spikes S in the flattened signal in FIG. 6a. The error, i.e. the difference between the original and reconstructed signals is shown in FIG. 6c, which reveals that the large peaks in the error signal in FIG. 5c have now been largely eliminated and in general the error signal looks more like a random signal.

FIGS. 7,8 and 9 and the corresponding description reflect the disclosure in a document with the applicant's internal reference PHNL031414EPP suitably adapted to the present invention.

In FIG. 7, an encoder is shown which in accordance with the invention combines the RPE plus extra pulses technique with a parametric encoder. The combination of a parametric encoder with an RPE encoder has been described in a document with the applicant's internal reference PHNL031414EPP. The parametric encoder is described in WO 01/69593. In FIG. 7 an input audio signal s is first processed within block TSA, (Transient and Sinusoidal Analysis). This block generates the associated parameters for transients and sinusoids. Given the bit rate B, a block BRC (Bit Rate Control) preferably limits the number of sinusoids and preferably preserves transients such that the overall bit rate for sinusoids and transients is at most equal to B, typically set at around 20 kbit/s.

A waveform is generated by block TSS (Transient and Sinusoidal Synthesiser) using the transient and sinusoidal parameters (CT and CS) generated by block TSA and modified by the block BRC. This signal is subtracted from input signal s, resulting in signal r1. In general, signal r1 does not contain substantial sinusoids and transient components.

From signal r1, the spectral envelope is estimated and removed in the block (SE) using a Linear Prediction filter, e.g. based on a tapped-delay-line or a Laguerre filter. The prediction coefficients Ps of the chosen filter are written to an audio bit stream AS for transmittal to a decoder as part of the conventional type noise codes C_{N}. Then the temporal envelope is removed in the block (TE) generating, for example, Line Spectral Pairs (LSP) or Line Spectral Frequencies (LSF) coefficients together with a gain, again as described in the prior art. In any case, the resulting coefficients Pt from the temporal flattening are written to the audio bit stream AS for transmittal to the decoder as part of the conventional type noise codes C_{N}. Typically, the coefficients Ps and PT require a bit rate budget of 4-5 kbit/s.

Because pulse train coders employ a first spectral flattening stage, the residual modelling stage 11 from FIG. 3 can be selectively applied on the spectrally flattened signal r₂ produced by the block SE according to whether or not a bit rate budget has been allocated to the residual modelling. In an alternative embodiment, indicated by the dashed line, the residual modelling is applied to the spectrally and temporally flattened signal r₃ produced by the block TE. The outputs from the residual modelling (px and pEP) are contained in the data L₀.

Experiments have shown that residual modelling sometimes results in a loss in brightness in the reconstructed signal when using few pulses (e.g. RPE with high decimation factors (e.g. D=8) or CELP with sparse codebooks. Adding some low-level noise to the excitation mitigates this problem. In order to determine the level of the noise, a gain (g) is calculated on basis of, for example, the energy/power difference between a signal generated from the excitation and residual signal r₂/r₃. This gain is also transmitted to the decoder as part of the layer L₀ information.

In the applicant's internal reference PHNL031414EPP FIG. 7 was described but with the residual modelling being an RPE modeller. Nevertheless it was found that also in the case of combination with parametric modelling the inclusion of extra pulses in the excitation signal is beneficial from a quality point-of-view at the cost of a minor increase in bit rate.

In FIG. 8 is shown a decoder that is compatible with the encoder of FIG. 7. A de-multiplexer (DEMUX) reads an incoming audio bit stream AS and provides the sinusoidal, transient and noise codes (C_{S}, C_{T} and C_{N}(PS, Pt)) to respective synthesizers SiS, TrS and TEG/SEG as in the prior art. As in the prior art, a white noise generator (WNG) supplies an input signal for the temporal envelope generator TEG. In the embodiment, where the information is available, a residual generator equal to 22 in FIG. 4 generates an excitation signal from layer L₀ and this is mixed in block Mx to provide an excitation signal r₂′. It will be seen from the encoder, that as the noise codes C_{N} (Ps, Pt) and layer L₀ were generated independently from the same residual r₂, the signals they generate need to be gain modified to provide the correct energy level for the synthesized excitation signal r₂′. In this embodiment, in a mixer (Mx), the signals produced by the blocks TEG and excitation generator are combined.

The excitation signal r₂′ is then fed to a spectral envelope generator (SEG) which according to the codes Ps produces a synthesized noise signal r₁′. This signal is added to the synthesized signals produced by the conventional transient and sinusoidal synthesizers to produce the output signal \hat{x}.

In an alternative embodiment, parameters generated by the excitation generator are used (indicated by the hashed line) in combination with the noise code Pt to shape the temporal envelope of the signal outputted by WNG to create a temporally shaped noise signal.

In FIG. 9 is shown a second embodiment of the decoder that corresponds with the embodiment of FIG. 7 where the residual modelling stage processes the residual signal r₃. Here, the signal generated by a white noise generator (WNG) and processed by a block We, based on the gain (g) and C_{N} determined by the encoder; and the excitation signal generated by the excitation generator are added to construct an excitation signal r₃′. Of course, where layer L₀ information is not available, the white noise is unaffected by the block We and provided as the excitation signal r₃′ to a temporal envelope generator block (TEG).

The temporal envelope coefficients (Pt) are then imposed on the excitation signal r₃′ by the block TEG to provide the synthesized signal r₂′ which is processed as before. As mentioned above, this is advantageous because the excitation signal typically gives rise to some loss in brightness, which, with a properly weighted additional noise sequence, can be counteracted. The weighting can comprise simple amplitude or spectral shaping each based on the gain factor g and C_{N}.

As before, the signal is filtered by, for example, a linear prediction synthesis filter in block SEG (Spectral Envelope Generator), which adds a spectral envelope to the signal. The resulting signal is then added to the synthesized sinusoidal and transient signal as before.

It will be seen that in either FIG. 8 or FIG. 9 that if no excitation generator is being used, the decoding scheme resembles the conventional sinusoidal encoder using a noise encoder only. If the excitation generator is used, an excitation signal is added, which enhances the reconstructed signal i.e. provides a higher audio quality.

It should be noted that in the embodiment of FIG. 9, in contrast to the standard pulse encoder (RPE or MPE), where a gain which is fixed for a complete frame is used, a temporal envelope is incorporated in the signal r₂′. By using such a temporal envelope, a better sound quality can be obtained, because of the higher flexibility in the gain profile compared to a fixed gain per frame.

The hybrid method described above can operate at a wide variety of bit rates, and at every bit rate it offers a quality comparable to that of state-of-the-art encoders. In that method the base layer, which is made up by the data supplied by the parametric (sinusoidal) encoder, contains the main or basic features of the input signal, and medium to high quality audio signal is obtained at a very low bit rate.

Similarly to the change in the encoder of FIG. 7 with respect to PHNL031414EPP, the decoders of FIGS. 8 and 9 have been adapted. The blocks PTG from PHNL031414EPP have been replaced by the excitation generator 22 from FIG. 4.

### REFERENCES

[1] P. Kroon, E. D. F. Deprettere, and R. J. Sluyter. Regular-pulse excitation—a novel approach to effective and efficient multipulse coding of speech. IEEE Trans. Acoustics, Speech and Signal Processing, 34:1054-1063, 1986.
[2] B. S. Atal and J. R Remde. A new model of lpc excitation for producing natural-sounding speech at low bit rates. Proc. IEEE ICASSP-82, pages 614-617, April 1982.
[3] R. P. Ramachandran and P. Kabal. Pitch prediction filters in speech coding. IEEE Trans. Acoust. Speech Signal Process., 37:467-478, 1989.
[4] R. P. Ramachandran and P. Kabal. Stability and performance analysis of pitch filters in speech coders. IEEE Trans. Acoust. Speech Signal Process., 35:937-945, 1987.
[5] S. Singhal. High quality audio coding using multipulse lpc. Proc. IEEE ICASSP-90, pages 1101-1104, 3-6 Apr. 1990.
[6] X. Lin, R. A. Salami, and R. Steele. High quality audio coding using analysis-by-synthesis technique. Proc. IEEE ICASSP-91, pages 3617-3620, 14-17 Apr. 1991.
[7] A. Harma, M. Karjalainen, L. Savioja, V. Välimäki, U. K. Laine, and J. Huopaniemi. Frequency-warped signal processing for audio applications. J. Audio Eng. Soc., 48:1011-1031, 2000.
[8] R. Yu and C. C. Ko. A warped linear-prediction-based subband audio coding algorithm. IEEE Trans. Speech Audio Process., 10:1-8, 2002.
[9] G. D. T. Schuller, B. Yu, D. Huang, and B. Edler. Perceptual audio coding using adaptive pre- and post-filter and lossless compression. IEEE Trans. Speech and Audio Processing, 10:379-390, 2002.
[10] W. B. Kleijn and K. K. Paliwal (Eds). Speech coding and synthesis, Elsevier, 1995, Amsterdam, pp. 79-119.

1. A method of encoding a digital audio signal, wherein for each time segment of the signal the following steps are performed:
spectrally flattening the signal to obtain a spectrally flattened signal (r),
modelling the spectrally flattened signal by an excitation signal comprising first and second partial excitation signals,
the first partial excitation signal (pₓ) conforming to an excitation signal generated by an RPE or CELP pulse modelling technique,
the second partial excitation signal (p_{EP}) being a set of extra pulses (P) modelling spikes (S) in the spectrally flattened signal, the extra pulses having arbitrary positions and amplitudes, and
generating an audio bit stream comprising the first and second partial excitation signals.

2. A method according to claim 1, wherein the one or more extra pulses (P) are added to the excitation signal (x) at positions in time that correspond substantially to the time of occurrence of the spikes (S).

3. A method according to claim 1, wherein the one or more extra pulses (P) are added to the excitation signal (x) at positions in time on an RPE time grid.

4. A method according to claim 1, wherein the pulses of the first partial excitation signal (pₓ) and the one or more extra pulses (P) of the second partial excitation signal (p_{EP}) are both at positions in time on an RPE time grid.

5. A method according to claim 3 where the positions of the extra pulses are determined as the positions of several extrema of an unquantised RPE excitation signal calculated from the residual signal.

6. A method according to claim 1 wherein the audio bit stream further comprises spectral flattening parameters (LPP).

7. An audio encoder adapted to encode time segments of a digital audio signal, the encoder comprising:
a spectral flattening unit for spectrally flattening the signal to output a spectrally flattened signal (r),
a calculating unit adapted to calculate, an excitation signal comprising first and second partial excitation signals,
the first partial excitation signal (pₓ) conforming to an excitation signal generated by an RPE or CELP technique
the second partial excitation signal (p_{EP}) being a set of extra pulses (P) modelling spikes (S) in the spectrally flattened signal, the extra pulses having arbitrary positions and amplitudes,
and
an audio bit stream generator for generating an audio bit stream comprising the first and second partial excitation signals.

8. An audio encoder according to claim 7, wherein the calculating unit is adapted to add the one or more extra pulses (P) to the excitation signal (x) at positions in time that correspond to the time of occurrence of the spikes (S).

9. An audio encoder according to claim 7, wherein the calculating unit is adapted to add the one or more extra pulses (P) to the excitation signal (x) at positions in time on an RPE time grid.

10. An audio encoder according to claim 7, wherein the pulses of the first partial excitation signal (pₓ) and the one or more extra pulses (P) of the second partial excitation signal (p_{EP}) are both at positions in time on an RPE time grid.

11. An audio encoder according to claim 7, where the positions of the extra pulses are determined as the positions of several extrema of an unquantised RPE excitation signal calculated from the residual signal.

12. An audio encoder according to claim 7, wherein the audio bit stream further comprises spectral flattening parameters (LPP).

13. A method of decoding a received audio bit stream (AS), where the audio bit stream comprises, for each of a plurality of segments of an audio signal:
a first partial excitation signal (pₓ) conforming to an excitation signal generated by an RPE or CELP pulse modelling technique,
a second partial excitation signal (p_{EP}) being a set of extra pulses (P) modelling spikes (S) in the spectrally flattened signal, the extra pulses having arbitrary positions and amplitudes,
the method comprising means for synthesising an output signal on the basis of the combined first and second excitation signals and spectral flattening parameters (LPP).

14. A method according to claim 13, wherein the spectral flattening parameters (LPP) are generated using a backward-adaptive linear prediction algorithm.

15. A method according to claim 13, wherein the spectral flattening parameters (LPP) are contained in the audio bit stream.

16. An audio player for receiving and decoding an audio bit stream (AS), where the audio bit stream comprises for each of a plurality of segments of an audio signal:
a first partial excitation signal (pₓ) conforming to an excitation signal generated by an RPE or CELP technique,
a second partial excitation signal (p_{EP}) being a set of extra pulses (P) modelling spikes (S) in the spectrally flattened signal, the extra pulses having arbitrary positions and amplitudes,
the audio player comprising means for synthesising an output signal from the combined partial excitation signals and spectral flattening parameters (LPP).

17. An audio player according to claim 16 comprising means for generating the spectral flattening parameters (LPP) using a backward-adaptive linear prediction algorithm.

18. An audio player according to claim 16 adapted to use spectral flattening parameters (LPP) received with the audio bit stream (AS).

19. An audio bit stream (AS) comprising for each of a plurality of segments of an audio signal:
a first partial excitation signal (pₓ) conforming to an excitation signal generated by an RPE or CELP technique,
a second partial excitation signal (p_{EP}) being a set of extra pulses (P) modelling spikes (S) in the spectrally flattened signal, the extra pulses having arbitrary positions and amplitudes.

20. An audio bit stream (AS) according to claim 19 further comprising spectral flattening parameters (LPP).

21. A storage medium having an audio bit stream (AS) as claimed in claim 19 stored thereon.
